(19) United States
(12) Patent Application Publication
(10) Pub. No.: US 2018/0371365 A1
(43) Pub. Date: Dec. 27, 2018

(54) FABRIC SOFTENER COMPOSITIONS

(71) Applicant: The Procter & Gamble Company, Cincinnati, OH (US)

(72) Inventors: Eva Maria PEREZ-PRAT VINUESA, NEWCASTLE UPON TYNE (GB); Samuel Kimani NJOROGE, CINCINNATI, OH (US); Alan Edward SHERRY, NEWPORT, KY (US)

(21) Appl. No.: 16/005,734

(22) Filed: Jun. 12, 2018

Related U.S. Application Data
(60) Provisional application No. 62/522,827, filed on Jun. 21, 2017.

(51) Int. Cl. C11D 3/00; C11D 3/30; C11D 3/32

(52) U.S. Cl. CPC C11D 3/001; C11D 3/32; C11D 3/30

(57) ABSTRACT

A fabric softener composition including (i) 2 to 50 wt % quaternary ammonium ester fabric softener compound; and (ii) an amide of formula I:

R1-CO—NR2R3 (I)

wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups, and methods of treating a fabric including contacting the fabric with the composition.

### FIELD OF INVENTION

This invention relates to fabric treatment compositions, in particular fabric softener compositions, methods of treating fabrics with a fabric softener composition and fabric laundering/washing processes comprising treating fabrics with a fabric softener composition.

### BACKGROUND OF THE INVENTION

Fabric softener compositions, typically added in a rinse step of a fabric laundering process are often added to provide fabric softness. However, soils may adhere to the deposited fabric softener composition and subsequent laundering processes may give incomplete removal of the fabric softener composition so that residues may remain. Build up of soils over time is undesirable for both coloured and white fabrics but may be particularly noticeable on white or pale-coloured fabrics, for example around collars and cuffs where incomplete cleaning occurs. These soils may exacerbate malodour, which may particularly develop if the fabric is not dried immediately, or even is re-wet and stays damp for some time: for example leaving wet laundry in a washing machine for over 20 minutes or longer prior to drying; line-drying in a warm, humid environment or indoors; damp fabrics such as towels or sportswear left prior to washing.

There is therefore a need for a fabric softener composition that addresses one or more of these problems, enabling laundering and fabric treatment processes that provide good cleaning and malodour reduction.

### SUMMARY OF THE INVENTION

This invention relates to a fabric softener composition comprising (i) from 2 to 50 wt % quaternary ammonium ester fabric softener compound and (ii) an amide of formula I:

R1-CO—NR2R3 (I)

wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups; and optionally an antimicrobial active. Preferably the fabric softener composition is a liquid.

The present invention also provides a method of treating a fabric, the method comprising contacting the fabric with a composition comprising (i) quaternary ammonium ester fabric softener compound and (ii) an amide of formula I:

R1-CO—NR2R3 (I)

wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups; and optionally an antimicrobial active. The fabric may be contacted with the composition for example in a rinse step of a laundering process or in a fabric drying step. In a preferred method, the method comprises (i) in a laundering/wash step, treating a fabric with an aqueous wash liquor comprising from 0.1 g/l to 5 g/l of a surfactant system, preferably comprising anionic and/or nonionic surfactant; (ii) optionally rinsing the textile one or two or more times with water; and (iii) in a post-wash-treatment step, contacting the fabric with (i) quaternary ammonium ester fabric softener compound and (ii) an amide of formula I:

R1-CO—NR2R3 (I)

wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups; and optionally an antimicrobial active. Preferably step (iii) is a rinse step in which fabric is contacted with a rinse liquor comprising water and the fabric softener composition, followed by (iv) drying the fabric. A further additional rinse step may be provided between steps (iii) and (iv) however it may be preferred for the fabric to be dried immediately after step (iii). The post wash-treatment step may be a drying step in which, for example, the fabric softener composition may be contacted with the fabric from substrate-laden product such as a dryer-added sheet.

### DETAILED DESCRIPTION OF THE INVENTION

### Definitions

As used herein, the term “alkoxy” is intended to include C1-C8 alkoxy and C1-C8 alkoxy derivatives of polyols having repeating units such as butylene oxide, glycidol oxide, ethylene oxide or propylene oxide.

As used herein, the terms “active” and “agent” are used interchangeably.

As used herein, unless otherwise specified, the terms “alkyl” and “alkyl capped” are intended to include C1-C18 alkyl groups, or even C1-C6 alkyl groups.

As used herein, unless otherwise specified, the term “aryl” is intended to include C3-12 aryl groups.

As used herein, unless otherwise specified, the term “arylalkyl” and “alkaryl” are equivalent and are each intended to include groups comprising an alkyl moiety bound to an aromatic moiety, typically having C1-C18 alkyl groups and, in one aspect, C1-C6 alkyl groups.

The terms “ethylene oxide,” “propylene oxide” and “butylene oxide” may be shown herein by their typical designation of “EO,” “PO” and “BO,” respectively.

As used herein, the term “cleaning or detergent composition” includes, unless otherwise indicated, granular, powder, liquid, gel, paste, unit dose, bar form and/or flake type washing agents products for laundering fabrics.

As used herein “average molecular weight” is reported as an average molecular weight, as determined by its molecular weight distribution: as a consequence of their manufacturing process, polymers disclosed herein may contain a distribution of repeating units in their polymeric moiety.

As used herein, articles such as “a” and “an” when used in a claim, are understood to mean one or more of what is claimed or described.

As used herein, the terms “include/s” and “including” are meant to be non-limiting.

The terms “microorganism” or “microbe” as used herein are intended to include cellular organisms, both unicellular and multicellular that are less than 5 mm in length, and include but are not limited to bacteria, fungi, prions, enveloped and non-enveloped viruses, archaea, protists, protozoa or oocysts formed by protozoa, green algae, plankton, planarian, amoebas and yeasts, or spores formed by any of these. The terms “microorganism” or “microbe” include the single or planktonic microbes that may contaminate surfaces, as well as communities of microbes that grow as biofilms on surfaces.

The term “antimicrobial” as used herein refers to a compound that exhibits microbicide or microbiostatic properties that enables the compound to kill, destroy, inactivate, or neutralize a microorganism; or to mitigate, prevent, or reduce the growth, ability to survive, or propagation of a microorganism. In the context of antimicrobial, the term “treat” means to kill, destroy, inactivate, or neutralize a microorganism; or to prevent or reduce the growth, ability to survive, or propagation of a microorganism

As used herein, the term “solid” includes granular, powder, bar and tablet product forms.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total softener composition unless otherwise indicated.

Unless otherwise noted, all component or composition levels are in reference to the active portion of that component or composition, and are exclusive of impurities, for example, residual solvents or by-products, which may be present in commercially available sources of such components or compositions.

All measurements are performed at 25° C. unless otherwise specified.

### The Quaternary Ammonium Ester Fabric Softener Compound

The fabric softener compound composition of the present invention comprises a fabric softener compound comprising a quaternary ammonium ester softening active (Fabric Softening Active, “FSA”), preferably in an amount from 2 to 50 by weight of the composition. In preferred fabric softener compositions, the quaternary ammonium ester softening active is present at a level from 3.0% to 30%, more preferably from 3.0% to 18 or 20%, even more preferably from 7.0% to 15% by weight of the composition. The level of quaternary ammonium ester softening active may depend on the desired concentration of total softening active in the composition (diluted or concentrated composition) and on the presence or not of other softening active. Higher levels give rise to a risk of dispenser residues when delivered from in washing machines or unstable viscosity over time.

Suitable quaternary ammonium softening compounds (quats) include but are not limited to materials selected from the group consisting of monoester quats, diester quats, triester quats and mixtures thereof. Preferably, the level of monoester quat is from 2.0% to 40.0%, the level of diester quat is from 40.0% to 98.0%, the level of triester quat is from 0.0% to 25.0% by weight of total quaternary ammonium ester softening active.

Said quaternary ammonium ester softening active may comprise compounds of the following formula:

{R²₍₄₋ₘ₎—N⁺—[X—Y—R¹]ₘ}A⁻

wherein:
m is 1, 2 or 3 with proviso that the value of each m is identical;
each R¹ is independently hydrocarbyl, or branched hydrocarbyl group, preferably R¹ is linear, more preferably R¹ is partially unsaturated linear alkyl chain;
each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂₋₃ alkoxy), polyethoxy, benzyl;
each X is independently (CH₂)n, CH₂—CH(CH₃)— or CH—(CH₃)—CH₂— and
each n is independently 1, 2, 3 or 4, preferably each n is 2;
each Y is independently —O—(O)C— or —C(O)—O—;
A− is independently selected from the group consisting of chloride, methyl sulfate, and ethyl sulfate, preferably A− is selected from the group consisting of chloride and methyl sulfate;
with the proviso that when Y is —O—(O)C—, the sum of carbons in each R¹ is from 13 to 21, preferably from 13 to 19.

In preferred liquid fabric softener compositions, the iodine value of the parent fatty acid from which the quaternary ammonium fabric softening active is formed is from 0 to 100, more preferably from 10 to 60, even more preferably from 15 to 45.

Examples of suitable quaternary ammonium ester softening actives are commercially available from KAO Chemicals under the trade name Tetranyl AT-1 and Tetranyl AT-7590, from Evonik under the tradename Rewoquat WE16 DPG, Rewoquat WE18, Rewoquat WE20, Rewoquat WE28, and Rewoquat 38 DPG, from Stepan under the tradename Stepantex GA90, Stepantex VR90, Stepantex VK90, Stepantex VA90, Stepantex DC90, Stepantex VL90A.

These types of agents and general methods of making them are disclosed in U.S. Pat. No. 4,137,180.

### Amide

The compositions disclosed herein may comprise an amide of formula I,

R1-CO—NR2R3 (I)

where R1 is selected from the group consisting of linear or branched, substituted or unsubstituted C6-C12, or C6-C10 hydrocarbyl groups, each of R2 and R3 is independently selected from H, OH, a halogen, or C1-C6 linear or branched, substituted or unsubstituted hydrocarbyl groups.

The compositions disclosed herein may comprise from about 0.01%, or from about 0.03%, or from about 0.05% to about 15%, or to about 25%, or to about 40% by weight of an amide of formula I.

A concentrated composition may comprise from about 1% to about 40%, or from about 1% to about 25%, or from about 1% to about 15%, or from about 1% to about 8%, or from about 1% to about 5%, or from about 1% to about 3% by weight of an amide of formula I. A concentrated antimicrobial composition may comprise from about 3% to about 40%, or from about 3% to about 15%, from about 3% to about 8%, from about 3% to about 5% by weight of an amide of formula I. A concentrated antimicrobial composition may comprise from about 5% to about 40%, or from about 5% to about 15%, or from about 5% to about 8% by weight of an amide of formula I. A concentrated composition may comprise from about 8% to about 40%, or from about 8% to about 15% by weight of an amide of formula I. A concentrated composition may comprise from about 15% to about 40% by weight of an amide of formula I. A ready-to-use composition may comprise from about 0.01% to about 0.50%, or from about 0.01% to about 0.20%, or from about 0.01% to about 0.10%, or from about 0.01% to about 0.05% by weight of an amide of formula I. A ready-to-use composition may comprise from about 0.05% to about 0.50%, or from about 0.05% to about 0.20%, or from about 0.05% to about 0.10% by weight of an amide of formula I. A ready-to-use composition may comprise from about 0.10% to about 0.50%, or from about 0.10% to about 0.20% by weight of an amide of formula I. A ready-to-use composition may comprise from about 0.20% to about 0.50% by weight of an amide of formula I. Ready-to-use compositions may comprise greater than 0.50% by weight of an amide of formula I, for example, to treat surfaces contaminated with mycobacteria, spore forming organisms, or biofilms. The weight ratio of surfactant to amide of formula I may be from about 0.05:1 to about 10:1, or from about 0.1:1 to about 5:1, or from about 0.2:1 to about 5:1, or from about 0.25:1 to about 5:1.

The composition(s) disclosed herein may comprise surfactant, which comprises from about 6 to about 12 carbon atoms, and an amide of formula I, where the weight ratio of the surfactant to the amide of formula I is from about 0.25:1 to about 5:1.

Amides of formula I include monounsaturated amides, saturated amides, and hydroxamic acids. Non-limiting examples of amides of formula I include n-octanamide, N-hexyl-N-methyl decanamide, N,N-diethanol octanamide, N,N-dibutyl hexanamide, octanohydroxamic acid, and N,N-diethanol dodecanamide. The composition(s) disclosed herein may comprise amide of formula I, wherein the amide of formula I is selected from the group consisting of N,N-dimethyl octanamide, N,N-dimethyl decanamide, N,N-dimethyl 9-decenamide, N.N-dimethyl 7-octenamide, octanohydroxamic acid, and mixtures thereof. It is noted that C6-12 hydroxamic acids, such as octanohydroxamic, may also provide chelation. For example, octanohydroxamic acid is known to have transition metal chelation properties, especially with respect to iron cations. As such, octanohydroxamic acid may be used, as a chelator, in combination with another amide of formula I, to supplement the activity of other amide. Combinations of C6-12 hydroxamic acid or C6-10 hydroxamic acid and another amide of formula I may be beneficial in promoting enhanced antimicrobial activity. Commercially available amides of formula I include Genagen 4296®, an N,N-dimethyl decanamide available from Clariant, Steposol® MET 10U, a N,N-dimethyl 9-decenamide available from Stepan Company, Cola®Mid AL, a lauric acid N,N-diethanol amide available from Colonial Chemical, and octanohydroxamic acid available from TCI America. Additionally, Steposol® M-8-10 is a mixture comprising approximately 55-60% N,N-dimethyl octanamide and approximately 40-45% N,N-dimethyl decanamide, which is derived from coconut oil and available from the Stepan Company.

It is believed that the amides disclosed herein potentiate the activity of antimicrobial actives against a variety of microorganisms, including Gram-positive bacteria, Gram-negative bacteria, non-enveloped viruses, fungi, mycobacteria, and even spore-forming organisms, such as Clostridium difficile spores. These potentiating effects are surprising given that amides alone are not known to have strong antimicrobial activity. Without wishing to be bound by theory, it is believed that the lipophilic character of the amide contributes to these potentiating effects; the amide is believed to preferentially partition into the microorganism, versus remaining in its monomer form in the composition. This partitioning is believed to induce micelles in the composition to release more amide monomers, in order to re-establish thermodynamic equilibrium. The released amide monomers again preferentially partition into the microorganism and the whole series of events—where amide monomers are continuously created from micelles and are then used up against the target microorganism—may contribute to the rapid antimicrobial activity of the disclosed compositions. By quickly and continuously permeating though microorganism defenses, the amide compound may also potentiate the activity of antimicrobial actives that are present in the composition.

For example, a composition that comprises hydrogen peroxide, as an antimicrobial active, may exhibit enhanced Fenton chemistry, with iron or copper from the microorganism, and may generate increased concentrations of oxygen-based radicals, which may react with the amide to form peracids or other highly reactive oxygen species (particularly, but not necessarily, inside the microorganism). For a composition comprising ionic silver, as an antimicrobial active, the nitrogen atom of the amide may associate with ionic silver, via a Lewis acid-base interaction, and may help to transport the silver ion into a microorganism, where it may cause death via known mechanisms.

The amide(s) disclosed herein may hydrolyze, over time, to its corresponding fatty acid, due to the acidic pH of the composition, particularly at a pH ranging from about 1 to about 2.5, and/or at increased temperatures (e.g., above room temperature). Preferably the pH is greater than 2.5. In particular if the pH is below 2.5, the compositions disclosed herein may therefore comprise a mixture of amide and its corresponding fatty acid. The fatty acid formed via hydrolysis may also contribute to antimicrobial activity, especially for compositions comprising hydrogen peroxide.

For compositions comprising the amide of formula I and hydrogen peroxide, peracids may be formed via the following reactions:

R1-C(O)N(R2)(R3)+H2O═R1C(O)OH+NH(R2)(R3); and

R—C(O)OH+H2O2=R—C(O)OOH+H2O.

As amide hydrolysis is catalyzed by acid, increasing the pH of the composition may reduce amide hydrolysis, thereby reducing the concentration of peracid.

The level of fatty acid formed by amide hydrolysis may optionally be adjusted by the addition of from about 0.1% to about 10% of a lower alcohol, a primary C1-C6 amine, a secondary C1-C6 amine, a C1-C6 alkanol amine, or a mixture thereof to the composition. Suitable lower alcohols include methanol, ethanol, propylene glycol, dipropylene glycol, diethyleneglycol, glycerol, diglycerol, polyglycerol, or C1 to C8 mono- or di-glycerol ethers. The compositions disclosed herein may further comprise an ester. The compositions disclosed herein may comprise a mixture of amide(s), fatty acid(s) (e.g., generated via hydrolysis of the amide), and ester(s). Esters typically have desirable odor profiles.

### Acidifying Agent

The pH of the neat fabric softener composition (see Methods) of the invention is preferably in the range from 1 to 8. Preferably the pH is acidic to improve hydrolytic stability of the quaternary ammonium ester softening active and may be from pH 2.0 to 6.0, preferably from pH 2.0 to 5.5, more preferably from 2.0 to 5.0 or 2.5 to 3.5.

The acidifying agent may adjust the pH to the desired acidity and/or may help stabilize the pH of the composition by providing buffering capacity. The acidifying agent may also sequester transition metals, including iron, copper, manganese and the like. The acidifying agent may be chosen to further enhance the antimicrobial activity of the composition.

The acidifying agent may be a US EPA/Health Canada registered active or a European notified antimicrobial substance.

The acidifying agent may comprise an organic acid, an inorganic acid, or a mixture thereof. The acidifying agent may be substantially free of trace transition metal impurities. Suitable inorganic acids include phosphoric acid, sulfuric acid, urea-sulfuric acid, hydrochloric acid, sulfamic acid, methyl sulfuric acid, hypochlorous acid, sodium bisulfate, and the like. Suitable organic acids include polymeric acids comprising at least 3 carboxylic acid groups, C1-C11 organic acids comprising at least one carboxylic acid group, and organic acids that do not comprise carboxylic acid functional groups (such as imidazole derivatives or phenolic or polyphenolic compounds). Non-limiting examples of polymeric acids include polymers of acrylic acid, methacrylic acid, maleic acid, or itaconic acid or copolymers of acrylic acid, methacrylic acid, maleic acid, itaconic acid, or mixtures thereof. Polymeric acids may be homopolymers or copolymers having a molecular weight of about 500 g/mol or greater. The polymeric acid may have a molecular weight ranging from about 500 g/mol to about 1,000,000 g/mol, or from about 500 g/mol to about 100,000 g/mol, or from about 1,000 g/mol to about 20,000 g/mol. Copolymers may be random copolymers or block copolymers. In addition to monomer units comprising carboxylic acid groups, the copolymers may also include one or more other monomers, such as styrene, acrylic ester, acrylamide, olefin sulfonate, and olefin acetate.

Non-limiting examples of C1-C11 organic acids include formic acid, acetic acid, benzoic acid, malonic acid, citric acid, maleic acid, fumaric acid, succinic acid, lactic acid, malic acid, tartaric acid, gluconic acid, glutaric acid, adipic acid, 2-ethyl-1-hexanoic acid, heptanoic acid, octanoic acid, nonanoic acid, undecylenic acid, butane tetracarboxylic acid, and the like. The organic acid may be derived from a renewable, plant-based feedstock and produced using natural processes, such as fermentation; examples include bio-based acetic acid, bio-based citric acid, bio-based lactic acid and bio-based succinic acid, and the like. The organic acid may have food-use pedigree or be Generally Regarded As Safe (GRAS) or a food additive by the US Food & Drug Administration.

Preferred acidifying agents may be selected from the group consisting of formic acid, acetic acid, benzoic acid, malonic acid, citric acid, maleic acid, fumaric acid, hypochlorous acid, succinic acid, gluconic acid, glutaric acid, lactic acid, succinic acid, salicylic acid, 2-ethyl-1-hexanoic acid, octanoic acid, nonanoic acid, peracetic acid, peroctanoic acid, undecylenic acid, and mixtures thereof, or the acidifying agent is selected from the group consisting of benzoic acid, citric acid, lactic acid, succinic acid, maleic acid, succinic acid, octanoic acid, and mixtures thereof. Preferred acidifying agents are selected from the group consisting of formic acid, citric acid, lactic acid, salicylic acid and succinic acid and mixtures thereof.

The compositions may comprise from about 0.01% to about 40%, or from about 0.03% to about 25%, or from about 0.05% to about 10% acidifying agent. A composition may comprise from about 0.5% to about 1%, or from about 1% to about 3%, or from about 3% to about 5%, or from about 5% to about 10%, or from about 10% to about 20%, or from about 20% to about 40% of acidifying agent. An increased concentration of acidifying agent increases the composition's reserve buffering capacity, which reduces pH fluctuation upon dilution. Partial neutralization of the acidifying agent to a pH value just below its pKa (e.g., 0.1 to 0.5 pH units below the acidifying agent's pKa) may also help to reduce pH fluctuation upon dilution. A concentrate may therefore be formulated at an increased pH, without compromising in-use (diluted) performance.

An increased pH may be preferred for enhanced compatibility of the composition with a larger variety of optional adjuncts, and to provide the benefits of the invention whilst being most mild to fabrics and machines in which the fabric treatment is carried out. For compositions having pH 3.5 or greater, the acidifying agent may be selected from acidifying agents having pKa values greater than about 3.7 or even greater than 4.0; non-limiting examples of such acidifying agents include lactic acid (pKa=3.9), acetic acid (pKa=4.8), succinic acid (pKa 4.2), benzoic acid (pKa=4.2), trans-cinnamic acid (pKa=4.4), p-coumaric acid (4-hydroxy cinnamic acid, pKa=4.6), octanoic acid (pKa 4.9), undecylenic acid (pKa 5.0), heptanoic acid (pKa=5.1), nonanoic acid (pKa=5.2), imidazole (pKa=7.0), hypochlorous acid (pKa=7.0) and mixtures thereof. Diprotic acid salts, such as the monosodium salt of maleic acid (pKa2=6.1), and triprotic acid salts, such as the mono- and dibasic salts of citric acid (pKa2=4.5, pKa3=6.4), may also be used to adjust the pH of the composition to pH 4.0 and greater.

The acidifying agent may be selected from the group consisting of benzoic acid, citric acid, succinic acid, glycolic acid, lactic acid, octanoic acid, hypochlorous acid, peroxyacetic acid, peroxyoctanoic acid, and mixtures thereof. Acids characterized by reduced water solubility, including succinic acid, benzoic acid, cinnamic acid and octanoic acid, may be especially beneficial.

### Antimicrobial Agent

The composition herein may comprise an antimicrobial agent. The antimicrobial agent is a compound that exhibits microbicide or microbiostatic properties that enables the compound to kill, destroy, inactivate, or neutralize a microorganism; or to mitigate, prevent, or reduce the growth, ability to survive, or propagation of a microorganism. In the context of antimicrobial, the term “treat” means to kill, destroy, inactivate, or neutralize a microorganism; or to prevent or reduce the growth, ability to survive, or propagation of a microorganism.

The antimicrobial agent is a material recognized by a governmental agency to provide antimicrobial activity. The antimicrobial active may be selected from the group consisting of cationic antimicrobial agents, organic acids, hydrogen peroxide, peroxyacetic acid, peroxyoctanoic acid, ionic silver compounds, and mixtures thereof.

The composition herein may comprise a cationic antimicrobial active such as a quaternary ammonium compound. Preferred quaternary ammonium compounds are those of the formula:

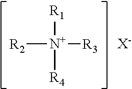

wherein at least one of R₁, R₂, R₃ and R₄ is a hydrophobic, aliphatic, aryl aliphatic or aliphatic aryl radical of from 6 to 26 carbon atoms, and the entire cation portion of the molecule has a molecular weight of at least 165. The hydrophobic radical(s) may be long-chain alkyl, long-chain alkoxy aryl, long-chain alkyl aryl, halogen-substituted long-chain alkyl aryl, long-chain alkyl phenoxy alkyl, aryl alkyl, etc. The remaining radicals on the nitrogen atoms other than the hydrophobic radicals are independently selected from substituents of a hydrocarbon structure usually containing a total of no more than 12 carbon atoms. The radicals R₁, R₂, R₃ and R₄ may be straight chained or may be branched, but are preferably straight chained. The radical X may be any salt-forming anionic radical, and preferably aids in the solubilization of the quaternary ammonium germicide in water. X can be a halide, for example a chloride, bromide or iodide, or X can be a methosulfate counterion, or X can be a carbonate ion.

Exemplary antimicrobial quaternary ammonium compounds include the alkyl ammonium halides such as cetyl trimethyl ammonium bromide, alkyl aryl ammonium halides such as octadecyl dimethyl benzyl ammonium bromide, N-alkyl pyridinium halides such as N-cetyl pyridinium bromide, and the like. Other very effective types of quaternary ammonium compounds which are useful as germicides include those in which the hydrophobic radical is characterized by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylbenzyltrimethyl ammonium chloride, chlorinated dodecylbenzyltrimethyl ammonium chloride, and the like.

More preferred antimicrobial quaternary ammonium compounds used in the compositions of the invention include those of the structural formula:

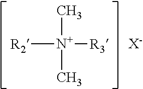

wherein R_{2′} and R_{3′} may be the same or different and are selected from C8-C12 alkyl, or R_{2′} is C12-C16 alkyl, C8-C18 alkylethoxy, C8-C18 alkylphenolethoxy and R_{3′} is benzyl, and X is a halide, for example a chloride, bromide or iodide, or X is a methosulfate counterion. The alkyl groups recited in R_{2′} and R_{3′} may be linear or branched, but are preferably substantially linear, or fully linear.

Particularly useful quaternary germicides include compositions presently commercially available under the tradenames BARDAC™, BARQUAT™, BTC™, and HYAMINE™. Particularly preferred is didecyl dimethyl ammonium chloride, such as supplied by Lonza under tradenames such as: Bardac 2250™, Bardac 2270™, Bardac 2270E™, Bardac 2280™, and/or a blend of alkyl, preferably C12-C18, dimethyl benzyl ammonium chloride and alkyl, preferably C12-C18, dimethyl ethylbenzyl ammonium chloride, such as supplied by Lonza under the brand name: Barquat 4280Z™. In preferred embodiments, the alkyl dimethyl benzyl ammonium chloride and alkyl dimethyl ethylbenzyl ammonium chloride are present in a ratio of from 20:80 to 80:20, or 40:60 to 60:40, with a ratio of 50:50 being the most preferred.

Other suitable, but less preferred, antimicrobial agents include germicidal amines, particularly germicidal triamines such as LONZA-BAC 12^{TM}, (ex. Lonza, Inc., Fairlawn, N.J. and/or from Stepan Co., Northfield Ill., as well as other sources).

When present the cationic antimicrobial agent is preferably at a level of from 0.01% to 0.9%, preferably from 0.015% to 0.5%, more preferably from 0.05% to 0.20% by weight of the composition.

The composition herein may comprise ionic silver as antibacterial agent, as used herein, “ionic silver,” refers to any silver (I) compound that may be solubilized or dispersed in an aqueous medium at a pH ranging from about 1.0 to about 8.0. Examples of ionic silver include silver acetate, silver lactate, silver nitrate, silver dihydrogen citrate, silver sulfate, silver citrate, as well as complexes of silver I formed with ammonia. When present, the composition typically comprises from about 0.001%, or from about 0.002%, or from about 0.003%, or from about 0.005% to about 0.25%, or to about 0.3%, or to about 0.5%, or to about 2% of ionic silver by weight of the composition.

The concentration of ionic silver is calculated as the weight percent of silver present in an ionic silver compound. For example, the weight percent of ionic silver in a composition comprising 0.1% silver nitrate is 0.064% [0.1%*(107.9/169.9)] and the weight percent of silver in a composition comprising 0.1% silver dihydrogen citrate is 0.036% [0.1%*107.9/300.0]. The concentration of ionic silver in the composition depends on the desired concentration of the overall composition (e.g., concentrate versus ready-to-use) as well as the antimicrobial benefits sought. Compositions comprising ionic silver may be substantially free of chloride ion, iodide ion, and/or bromide ion impurities; the compositions may comprise less than about 10 ppm chloride ion, less than about 10 ppm iodide ion, less than about 10 ppm bromide ion, or less than about 10 ppm of a mixture thereof, or less than about 1 ppm chloride ion, less than about 1 ppm iodide ion, less than about 1 ppm bromide ion, or less than about 1 ppm of a mixture thereof.

The composition herein may comprise hydrogen peroxide as antimicrobial agent. When present, hydrogen peroxide is typically at a level from about 0.01%, or from about 0.03%, or from about 0.05%, or from about 0.06%, or from about 0.07% to about 8%, or to about 10%, or to about 15%, or to about 20%, or to about 30% by weight of the composition.

Compositions comprising hydrogen peroxide preferably comprise less than about 5 ppm transition metal ion impurities, or less than about 2 ppm transition metal ion impurities, or less than 0.5 ppm transition metal ion impurities. Compositions comprising hydrogen peroxide preferably comprise less than about 5 ppm ferrous ion, less than about 5 ppm ferric ion, or less than about 5 ppm of a mixture thereof, or less than about 1 ppm ferrous ion, less than about 1 ppm ferric ion, or less than about 1 ppm of a mixture thereof, or less than about 0.1 ppm ferrous ion, less than about 0.1 ppm ferric ion, or less than about 0.1 ppm of a mixture thereof.

Compositions comprising hydrogen peroxide preferably comprise quaternary ammonium ester fabric softener compounds wherein the iodine value of the parent fatty acid from which the quaternary ammonium fabric softening active is formed is from 0 to 12.

The composition of the invention may comprise acidifying agent and an antimicrobial active, where the antimicrobial active comprises hydrogen peroxide, where the weight ratio of the acidifying agent to the hydrogen peroxide is from about 0.2:1 to about 5:1. The combination of acid and hydrogen peroxide may generate measurable concentrations of peracid, from the reaction of acid and hydrogen peroxide. The composition of the invention may, however, comprise hydrogen peroxide and be substantially free of C6-12 peracids. The composition of the invention may comprise hydrogen peroxide and peracid, where the peracid is formed in-situ via the reaction of a carboxylic acid-containing acidifying agent and hydrogen peroxide. For example, when the composition comprises octanoic acid or nonanoic acid, as the acidifying agent, there may be peroxyoctanoic acid or peroxynonanoic acid, respectively, formed in-situ in the composition. The rate of formation of the peracid may depend on the pH of the composition (reduced pHs favor peracid formation and faster rates of formation). The compositions disclosed herein may comprise hydrogen peroxide and peracid, where the peracid is formed in-situ via the reaction of the fatty-acid-product of amide hydrolysis and hydrogen peroxide. Peracid species may have various benefits, including antimicrobial benefits.

The composition may further comprise peracid from the in-situ reaction of acidifying agent with hydrogen peroxide, or peracid formed by hydrolysis/perhydrolysis of amides and esters in the composition; alternatively, the compositions may be substantially free of peracid, especially peracid formed from amide precursors of formula I.

The acidifying agent may provide acidity and/or buffering as disclosed above. The acidifying agent may be used as an antimicrobial. Thus, the compositions disclosed herein may comprise an unregistered (North America) or unnotified (Europe) acidifying agent. The compositions disclosed herein may comprise a registered (North America) or notified (Europe) acidifying agent. The compositions disclosed herein may comprise benzoic acid, citric acid, glycolic acid, oxalic acid, maleic acid, malic acid, tartaric acid, sorbic acid, lactic acid, succinic acid, salicylic acid, octanoic acid, hexanoic acid, peroxioctanoic acid.

The compositions disclosed herein may comprise ionic silver, hydrogen peroxide, cationic antimicrobial agents, unregistered (North America) or unnotified (Europe) acidifying agent, or mixtures thereof. The compositions disclosed herein may comprise ionic silver, hydrogen peroxide, cationic antimicrobial agent, registered (North America) or notified (Europe) acidifying agent, or mixtures thereof.

Benzoic acid, citric acid, lactic acid, hydrogen peroxide, and certain ionic silver compounds, such as silver nitrate, are approved for use for water treatment or on food contact surfaces in the USA. Additionally, citric acid, 1-lactic acid, and hydrogen peroxide are antimicrobial approved actives for the US EPA's Design for the Environment (DfE) pesticide pilot project. Lactic acid, citric acid, peroxyoctanoic acid, and hydrogen peroxide are also notified substances in the European Union.

The composition of the invention may comprise from about 1% to about 20%, or from about 1% to about 10% of acidifying agent; from about 0.01% to about 30%, or from about 0.05% to about 8%, or from about 0.1% to about 5% of antimicrobial active; from about 1% to about 35%, or from about 1% to about 10% of amide of formula I.

The composition(s) may comprise from about 1% to about 20%, or from about 1% to about 10% of acidifying agent; from about 0.01% to about 30%, or from about 0.05% to about 8%, or from about 0.1% to about 5% of antimicrobial active, wherein the antimicrobial active comprises a cationic antimicrobial agent; from about 1% to about 35%, or from about 1% to about 10% of amide of formula I, where the amide of formula I is selected from the group consisting of N,N-dimethyl octanamide, N,N-dimethyl decanamide, N,N-dimethyl 9-decenamide, N.N-dimethyl 7-octenamide, octanohydroxamic acid, and mixtures thereof.

The fabric softener composition herein is preferably a liquid fabric softener composition.

Liquid Fabric Softener Composition

As used herein, “liquid fabric softener composition” refers to any treatment composition comprising a liquid capable of softening fabrics e.g., clothing in a domestic washing machine. The composition can include solids or gases in suitably subdivided form, but the overall composition excludes product forms which are non-liquid overall, such as tablets or granules. The liquid fabric softener composition preferably has a density in the range from 0.9 to 1.3 g·cm-3, excluding any solid additives but including any bubbles, if present.

Aqueous liquid fabric softening compositions are preferred. For such aqueous liquid fabric softener compositions, the water content can be present at a level of from 5% to 97%, preferably from 50% to 96%, more preferably from 70% to 95% by weight of the liquid fabric softener composition.

The dynamic yield stress (see Methods) at 20° C. of the fabric softener composition is preferably from 0.001 Pa to 1.0 Pa, preferably from 0.002 Pa to 0.9 Pa, more preferably from 0.005 Pa to 0.8 Pa, even more preferably from 0.010 Pa to 0.5 Pa as this provides phase stability.

Although composition may have dynamic yield stress below these limits, such compositions may be more prone to phase instabilities, especially when the fabric softener composition comprises encapsulated benefit agents or particles. Higher dynamic yield stresses may lead to undesired air entrapment during filling of a bottle with the fabric softener composition.

The viscosity (see Methods) of the fabric softener composition is preferably from 200 mPa·s to 1000 mPa·s, preferably from 250 mPa·s to 900 mPa·s, more preferably from 300 mPa·s to 800 mPa·s, even more preferably from 350 mPa·s to 700 mPa·s at 20° C. These preferred viscosities provide a rich appearance while maintaining ease of pouring.

The liquid fabric softener composition may comprise further adjunct ingredients suitable for use in the instant compositions and may be desirably incorporated in certain aspects of the invention, for example to improve the aesthetics of the composition as is the case with pigments and dyes. Fabric softener compositions may be subject to some degree of UV light and/or oxidation which may give rise to increased risk of yellowing of the composition or of treated fabrics. The liquid fabric softener composition may comprise from 0.0001% to 0.1%, preferably from 0.001% to 0.05% of a dye by weight of the composition to counteract any such yellowing. Suitable dyes are selected from the list comprising bis-azo dyes, tris-azo dyes, azine dyes, triarylmethane dyes, anthraquinone dyes, and dye polymers such as cationic, anionic or nonionic polymeric dyes. Examples of dye polymers include alkoxylated dyes or dyes covalently bound to polyethyleneimines or cellulosic polymers.

### Cellulose Fibers:

Optionally the compositions of the invention may comprise cellulose fibers. These may be useful to thicken, and structure the fabric softener composition. They may be useful to help minimize the formation of dispenser residues. Where present, cellulose fibers are typically present in amounts from 0.01% to 5.0%, more preferably 0.05% to 1.0%, even more preferably from 0.10% to 0.75% of cellulose fibers by weight of the composition.

By cellulose fibers it is particularly meant herein cellulose micro or nano fibrils. The cellulose fibers can be of bacterial or botanical origin, i.e. produced by fermentation or extracted from vegetables, plants, fruits or wood. Cellulose fiber sources may be selected from the group consisting of citrus peels, such as lemons, oranges and/or grapefruit; fruits, such as apples, bananas and/or pear; vegetables such as carrots, peas, potatoes and/or chicory; plants such as bamboo, jute, abaca, flax, cotton and/or sisal, cereals, and different wood sources such as spruces, eucalyptus and/or oak. Preferably, the cellulose fibers source is selected from the group consisting of wood or plants, in particular, spruce, eucalyptus, jute, and sisal.

The content of cellulose in the cellulose fibers will vary depending on the source and treatment applied for the extraction of the fibers, and will typically range from 15% to 100%, preferably above 30%, more preferably above 50%, and even more preferably above 80% of cellulose by weight of the cellulose fibers.

Such cellulose fibers may comprise pectin, hemicellulose, proteins, lignin and other impurities inherent to the cellulose based material source such as ash, metals, salts and combinations thereof. The cellulose fibers are preferably non-ionic. Such fibers are commercially available, for instance Citri-Fi 100FG from Fiberstar, Herbacel® Classic from Herbafood, and Exilva® from Borregaard.

The cellulose fibers may have an average diameter from 10 nm to 350 nm, preferably from 30 nm to 250 nm, more preferably from 50 nm to 200 nm.

### Non-Ionic Surfactants

It may be preferred for the fabric softener composition to comprise nonionic surfactant, for example from 0.01% to 5%, preferably from 0.1% to 3.0%, more preferably from 0.5% to 2.0% of non-ionic surfactant based on the total fabric softener composition weight. Non-ionic surfactants may be useful to promote dispersion of disperse perfume or other poorly water-soluble components into the fabric softener composition and improve the overall dispersability of the fabric softener composition into water.

A preferred non-ionic surfactant is an alkoxylated non-ionic surfactant, preferably an ethoxylated non-ionic surfactant. Preferably the alkoxylated non-ionic surfactant has an average degree of alkoxylation of at least 3, preferably from 5 to 100, more preferably from 10 to 60. Preferred non-ionic surfactant will have a hydrophobic lipophilic balance value of 8 to 18.

Examples of suitable non-ionic surfactants are commercially available from BASF under the tradename Lutensol AT80 (ethoxylated alcohol with an average degree of ethoxylation of 80 from BASF), from Clariant under the tradename Genapol T680 (ethoxylated alcohol with an average degree of ethoxylation of 68), from Sigma Aldrich under the tradename Tween 20 (polysorbate with an average degree of ethoxylation of 20), from The Dow Chemical Company under the tradename Tergitol 15-S-30 (ethoxylated branched alcohol with an average degree of ethoxylation of 30).

### Dispersed Perfume

The liquid fabric softener composition of the present invention may comprise a dispersed perfume composition to provide a pleasant smell. By dispersed perfume is meant herein a perfume composition that is freely dispersed in the fabric softener composition and is not encapsulated. A perfume composition comprises one or more perfume raw materials. Perfume raw materials are the individual chemical compounds that are used to make a perfume composition. The choice of type and number of perfume raw materials is dependent upon the final desired scent. In the context of the present invention, any suitable perfume composition may be used. Those skilled in the art will recognize suitable compatible perfume raw materials for use in the perfume composition, and will know how to select combinations of ingredients to achieve desired scents.

Preferably, the level of dispersed perfume is from 0.1% to 10.0%, preferably from 0.5% to 7.5%, more preferably from 0.8% to 5.0% by total weight of the composition.

The perfume composition may typically comprise from 2.5% to 30%, preferably from 5% to 30% by total weight of perfume composition of perfume raw materials characterized by a log P lower than 3.0, and a boiling point lower than 250° C.

The perfume composition may typically comprise from 5% to 30%, preferably from 7% to 25% by total weight of perfume composition of perfume raw materials characterized by having a log P lower than 3.0 and a boiling point higher than 250° C. The perfume composition may comprise from 35% to 60%, preferably from 40% to 55% by total weight of perfume composition of perfume raw materials characterized by having a log P higher than 3.0 and a boiling point lower than 250° C. The perfume composition may comprise from 10% to 45%, preferably from 12% to 40% by total weight of perfume composition of perfume raw materials characterized by having a log P higher than 3.0 and a boiling point higher than 250° C.

### Particles

The fabric softener composition of the present invention may also comprise particles, when present typically in amounts from 0.02% to 10%, preferably from 0.1% to 4%, more preferably from 0.25% to 2.5% of particles based on the total liquid fabric softener composition weight. Said particles include beads, pearlescent agents, benefit agent encapsulates, and mixtures thereof.

### Encapsulated Benefit Agent:

The liquid fabric softener composition may comprise encapsulated benefit agent, typically in amounts from 0.05% to 10%, preferably from 0.05% to 3.0%, more preferably from 0.05% to 2.0% by weight. The benefit agent may be selected from the group consisting of perfume composition, moisturizers, heating or cooling agents, insect/moth repellent, germ/mould/mildew control agents, softening agents, antistatic agents, anti-allergenic agents, UV protection agents, sun fade inhibitors, hueing dyes, enzymes and combinations thereof, color protection agents such as dye transfer inhibitors, bleach agents, and combinations thereof. Perfume compositions are preferred.

The benefit agent is encapsulated, for instance, as part of a core in one or more capsules. Such cores can comprise other materials, such as diluents, solvents and density balancing agents.

The capsules have a wall, which at least partially, preferably fully surrounds the benefit agent-comprising core. The capsule wall material may be selected from the group consisting of melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof.

Preferably, the capsule wall comprises one or more wall material comprising melamine, polyacrylate based material and combinations thereof.

Suitable melamine wall material may be selected from the group consisting of melamine crosslinked with formaldehyde, melamine-dimethoxyethanol crosslinked with formaldehyde, and combinations thereof.

Suitable polyacrylate-based material may be selected from the group consisting of polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer and combinations thereof.

Said polystyrene wall material may be selected from polystyrene cross-linked with divinylbenzene.

Suitable polyurea capsules may comprise a polyurea wall which is the reaction product of the polymerisation between at least one polyisocyanate comprising at least two isocyanate functional groups and at least one amine, preferably a polyfunctional amine as a cross-linking and a colloidal stabilizer.

Suitable polyurethane capsules may comprise a polyureathane wall which is the reaction product of a polyfunctional isocyanate and a polyfunctional alcohol as a cross-linking agent and a colloidal stabilizer.

Suitable capsules can be obtained from Encapsys (Appleton, Wis., USA). The fabric softener compositions may comprise combinations of different capsules, for example capsules having different wall materials and/or benefit agents.

As mentioned earlier, perfume compositions are the preferred encapsulated benefit agent. The encapsulated perfume composition comprises perfume raw materials. The encapsulated perfume composition can further comprise essential oils, malodour-reducing agents, odour-controlling agents and combinations thereof. The encapsulated perfume raw materials are typically present in an amount of from 10% to 95%, preferably from 20% to 90% by weight of the capsule.

The encapsulated perfume composition may comprise from 2.5% to 30%, preferably from 5% to 30% by total weight of perfume composition of perfume raw materials characterized by a log P lower than 3.0, and a boiling point lower than 250° C.

The encapsulated perfume composition may comprise from 5% to 30%, preferably from 7% to 25% by total weight of perfume composition of perfume raw materials characterized by having a log P lower than 3.0 and a boiling point higher than 250° C. The perfume composition may comprise from 35% to 60%, preferably from 40% to 55% by total weight of perfume composition of perfume raw materials characterized by having a log P higher than 3.0 and a boiling point lower than 250° C. The perfume composition may comprise from 10% to 45%, preferably from 12% to 40% by total weight of perfume composition of perfume raw materials characterized by having a log P higher than 3.0 and a boiling point higher than 250° C.

### Ratio of Encapsulated Benefit Agent to Dispersed Perfume Oil

The liquid fabric softener composition may preferably comprise a ratio of perfume oil encapsulates to dispersed perfume oil by weight of from 1:1 to 1:40, preferably from 1:2 to 1:20, more preferably from 1:3 to 1:10.

### Further Perfume Delivery Technologies

The liquid fabric softener composition may comprise one or more perfume delivery technologies that stabilize and enhance the deposition and release of perfume ingredients from treated substrate. Such perfume delivery technologies can be used to increase the longevity of perfume release from the treated substrate. Perfume delivery technologies, methods of making certain perfume delivery technologies and the uses of such perfume delivery technologies are disclosed in US 2007/0275866 A1.

The liquid fabric softener composition may comprise from 0.001% to 20%, or from 0.01% to 10%, or from 0.05% to 5%, or even from 0.1% to 0.5% by weight of the perfume delivery technology. Said perfume delivery technologies may be selected from the group consisting of: pro-perfumes, cyclodextrins, starch encapsulated accord, zeolite and inorganic carrier, and combinations thereof.

Amine Reaction Product (ARP): For purposes of the present application, ARP is a subclass or species of pro-perfumes. One may also use “reactive” polymeric amines in which the amine functionality is pre-reacted with one or more PRMs to form an amine reaction product (ARP). Typically the reactive amines are primary and/or secondary amines, and may be part of a polymer or a monomer (non-polymer). Such ARPs may also be mixed with additional PRMs to provide benefits of polymer-assisted delivery and/or amine-assisted delivery. Nonlimiting examples of polymeric amines include polymers based on polyalkylimines, such as polyethyleneimine (PEI), or polyvinylamine (PVAm). Nonlimiting examples of monomeric (non-polymeric) amines include hydroxyl amines, such as 2-aminoethanol and its alkyl substituted derivatives, and aromatic amines such as anthranilates. The ARPs may be premixed with perfume or added separately in leave-on or rinse-off applications. A material that contains a heteroatom other than nitrogen, for example oxygen, sulfur, phosphorus or selenium, may be used as an alternative to amine compounds. The aforementioned alternative compounds can be used in combinations with amine compounds. A single molecule may comprise an amine moiety and one or more of the alternative heteroatom moieties, for example, thiols, and phosphines. The benefit may include improved delivery of perfume as well as controlled perfume release.

### Deposition Aid

The liquid fabric softener composition may comprise, based on the total liquid fabric softener composition weight, from 0.0001% to 3%, preferably from 0.0005% to 2%, more preferably from 0.001% to 1% of a deposition aid. The deposition aid may be a cationic or amphoteric polymer. The cationic polymer may comprise a cationic acrylate. Cationic polymers in general and their method of manufacture are known in the literature. Deposition aids can be added concomitantly with particles or directly in the liquid fabric softener composition. Preferably, the deposition aid is selected from the group consisting of polyvinylformamide, partially hydroxylated polyvinylformamide, polyvinylamine, polyethylene imine, ethoxylated polyethylene imine, polyvinylalcohol, polyacrylates, and combinations thereof.

The weight-average molecular weight of the polymer may be from 500 to 5000000 or from 1000 to 2000000 or from 2500 to 1500000 Dalton, as determined by size exclusion chromatography relative to polyethyleneoxide standards using Refractive Index (RI) detection. In one aspect, the weight-average molecular weight of the cationic polymer may be from 500 to 37500 Dalton.

### Additional Fabric Softening Active

The liquid fabric softener composition of the present invention may comprise from 0.01% to 10%, preferably from 0.1% to 10%, more preferably from 0.1% to 5% of additional fabric softening active. Suitable fabric softening actives, include, but are not limited to, materials selected from the group consisting of non-ester quaternary ammonium compounds, amines, fatty esters, sucrose esters, silicones, dispersible polyolefins, polysaccharides, fatty acids, softening oils, polymer latexes and combinations thereof.

Non-Ester Quaternary Ammonium Compounds:

Suitable non-ester quaternary ammonium compounds comprise compounds of the formula:

[R(4−m)—N+—R1m]X—

wherein each R comprises either hydrogen, a short chain C1-C6, in one aspect a C1-C3 alkyl or hydroxyalkyl group, for example methyl, ethyl, propyl, hydroxyethyl, poly(C2-3 alkoxy), polyethoxy, benzyl, or mixtures thereof; each m is 1, 2 or 3 with the proviso that the value of each m is the same; the sum of carbons in each R1 may be C12-C22, with each R1 being a hydrocarbyl, or substituted hydrocarbyl group; and X− may comprise any softener-compatible anion. The softener-compatible anion may comprise chloride, bromide, methylsulfate, ethylsulfate, sulfate, and nitrate. The softener-compatible anion may comprise chloride or methyl sulfate.

Non-limiting examples include dialkylenedimethylammonium salts such as dicanoladimethylammonium chloride, di(hard)tallowdimethylammonium chloride dicanoladimethylammonium methylsulfate, and mixtures thereof. An example of commercially available dialkylenedimethylammonium salts usable in the present invention is dioleyldimethylammonium chloride available from Witco Corporation under the trade name Adogen® 472 and dihardtallow dimethylammonium chloride available from Akzo Nobel Arquad 2HT75.

### Amines

Suitable amines include but are not limited to, materials selected from the group consisting of amidoesteramines, amidoamines, imidazoline amines, alkyl amines, and combinations thereof. Suitable ester amines include but are not limited to, materials selected from the group consisting of monoester amines, diester amines, triester amines and combinations thereof. Suitable amidoamines include but are not limited to, materials selected from the group consisting of monoamido amines, diamido amines and combinations thereof. Suitable alkyl amines include but are not limited to, materials selected from the group consisting of mono alkylamines, dialkyl amines quats, trialkyl amines, and combinations thereof.

### Fatty Acid

The liquid fabric softener composition may comprise a fatty acid, such as a free fatty acid as additional fabric softening active. The term “fatty acid” is used herein in the broadest sense to include unprotonated or protonated forms of a fatty acid. One skilled in the art will readily appreciate that the pH of an aqueous composition will dictate, in part, whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise).

The fatty acid may include those containing from 12 to 25, from 13 to 22, or even from 16 to 20, total carbon atoms, with the fatty moiety containing from 10 to 22, from 12 to 18, or even from 14 (mid-cut) to 18 carbon atoms.

The fatty acids may be derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, castor oil, etc.; (3) processed and/or bodied oils, such as linseed oil or tung oil via thermal, pressure, alkali-isomerization and catalytic treatments; (4) combinations thereof, to yield saturated (e.g. stearic acid), unsaturated (e.g. oleic acid), polyunsaturated (linoleic acid), branched (e.g. isostearic acid) or cyclic (e.g. saturated or unsaturated α-disubstituted cyclopentyl or cyclohexyl derivatives of polyunsaturated acids) fatty acids.

Mixtures of fatty acids from different fat sources can be used.

The cis/trans ratio for the unsaturated fatty acids may be important, with the cis/trans ratio (of the C18:1 material) being from at least 1:1, at least 3:1, from 4:1 or even from 9:1 or higher.

Branched fatty acids such as isostearic acid are also suitable since they may be more stable with respect to oxidation and the resulting degradation of color and odor quality.

The fatty acid may have an iodine value from 0 to 140, from 50 to 120 or even from 85 to 105.

### Polysaccharides

The liquid fabric softener composition may comprise a polysaccharide as additional fabric softening active, such as cationic starch. Suitable cationic starches for use in the present compositions are commercially-available from Cerestar under the trade name C*BOND® and from National Starch and Chemical Company under the trade name CATO® 2A.

### Sucrose Esters

The liquid fabric softener composition may comprise a sucrose esters as additional fabric softening active. Sucrose esters are typically derived from sucrose and fatty acids. Sucrose ester is composed of a sucrose moiety having one or more of its hydroxyl groups esterified.

Sucrose is a disaccharide having the following formula:

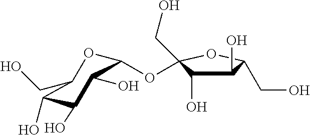

Alternatively, the sucrose molecule can be represented by the formula: M(OH)₈, wherein M is the disaccharide backbone and there are total of 8 hydroxyl groups in the molecule.

Thus, sucrose esters can be represented by the following formula:

M(OH)₈₋ₓ(OC(O)R¹)ₓ

wherein x is the number of hydroxyl groups that are esterified, whereas (8-x) is the hydroxyl groups that remain unchanged; x is an integer selected from 1 to 8, alternatively from 2 to 8, alternatively from 3 to 8, or from 4 to 8; and R¹ moieties are independently selected from C₁-C₂₂ alkyl or C₁-C₃₀ alkoxy, linear or branched, cyclic or acyclic, saturated or unsaturated, substituted or unsubstituted.

The R¹ moieties may comprise linear alkyl or alkoxy moieties having independently selected and varying chain length. For example, R¹ may comprise a mixture of linear alkyl or alkoxy moieties wherein greater than 20% of the linear chains are C₁₈, alternatively greater than 50% of the linear chains are C₁₈, alternatively greater than 80% of the linear chains are Cis.

The R¹ moieties may comprise a mixture of saturate and unsaturated alkyl or alkoxy moieties. The iodine value (IV) of the sucrose esters suitable for use herein ranges from 1 to 150, or from 2 to 100, or from 5 to 85. The R¹ moieties may be hydrogenated to reduce the degree of unsaturation. In the case where a higher IV is preferred, such as from 40 to 95, then oleic acid and fatty acids derived from soybean oil and canola oil are suitable starting materials.

The unsaturated R¹ moieties may comprise a mixture of “cis” and “trans” forms the unsaturated sites. The “cis”/“trans” ratios may range from 1:1 to 50:1, or from 2:1 to 40:1, or from 3:1 to 30:1, or from 4:1 to 20:1.

### Dispersible Polyolefins and Latexes:

Generally, all dispersible polyolefins that provide fabric softening benefits can be used as additional fabric softening active in the present invention. The polyolefins can be in the form of waxes, emulsions, dispersions or suspensions.

The polyolefin may be chosen from a polyethylene, polypropylene, or combinations thereof. The polyolefin may be at least partially modified to contain various functional groups, such as carboxyl, alkylamide, sulfonic acid or amide groups. The polyolefin may be at least partially carboxyl modified or, in other words, oxidized.

Non-limiting examples of fabric softening active include dispersible polyethylene and polymer latexes. These agents can be in the form of emulsions, latexes, dispersions, suspensions, and the like. In one aspect, they are in the form of an emulsion or a latex. Dispersible polyethylenes and polymer latexes can have a wide range of particle size diameters (χ₅₀) including but not limited to from 1 nm to 100 μm; alternatively from 10 nm to 10 μm. As such, the particle sizes of dispersible polyethylenes and polymer latexes are generally, but without limitation, smaller than silicones or other fatty oils.

Generally, any surfactant suitable for making polymer emulsions or emulsion polymerizations of polymer latexes can be used as emulsifiers for polymer emulsions and latexes used as fabric softeners active in the present invention. Suitable surfactants include anionic, cationic, and nonionic surfactants, and combinations thereof. In one aspect, such surfactants are nonionic and/or anionic surfactants. In one aspect, the ratio of surfactant to polymer in the fabric softening active is 1:5, respectively.

### Silicone:

The liquid fabric softener composition may comprise a silicone as additional fabric softening active. Useful silicones can be any silicone comprising compound. The silicone polymer may be selected from the group consisting of cyclic silicones, polydimethylsiloxanes, aminosilicones, cationic silicones, silicone polyethers, silicone resins, silicone urethanes, and combinations thereof. The silicone may be a polydialkylsilicone, alternatively a polydimethyl silicone (polydimethyl siloxane or “PDMS”), or a derivative thereof. The silicone may be chosen from an aminofunctional silicone, amino-polyether silicone, alkyloxylated silicone, cationic silicone, ethoxylated silicone, propoxylated silicone, ethoxylated/propoxylated silicone, quaternary silicone, or combinations thereof.

### Method

The present invention also provides a method of treating a fabric, the method comprising the steps of (i) in a laundering step, treating a fabric with an aqueous wash liquor comprising from 0.1 g/l to 5 g/l of a surfactant system, preferably comprising anionic and/or nonionic surfactant; (ii) optionally rinsing the fabric one or two or more times with water; and (iii) in a post wash-treatment step, contacting the fabric with the fabric softener composition. Preferably the post wash-treatment step is a rinse step and the rinse liquor comprises water and the fabric softener composition; and in a drying step (iv) the fabric is dried. A further additional rinse step may be provided between steps (iii) and (iv) however it may be preferred for the fabric to be dried immediately after step (iii).

Generally, an effective amount of a detergent composition is added to water, for example in a conventional washing step, to form the aqueous wash liquor. The aqueous wash liquor so formed is then contacted, typically under agitation, with the fabrics to be laundered. An effective amount of the detergent composition added to water to form aqueous laundering solutions can comprise amounts sufficient to form from about 500 to 25,000 ppm, or from 500 to 15,000 ppm of composition in aqueous washing solution, or from about 1,000 to 3,000 ppm of the detergent compositions herein will be provided in aqueous washing solution.

Typically, the wash liquor is formed by contacting the detergent with wash water in such an amount so that the concentration of the detergent in the wash liquor is from 0.1 g/l to 5 g/l, or from 1 g/l, and to 4.5 g/l, or to 4.0 g/l, or to 3.5 g/l, or to 3.0 g/l, or to 2.5 g/l, or even to 2.0 g/l, or even to 1.5 g/l.

The wash liquor may comprise 40 litres or less of water, or 30 litres or less, or 20 litres or less, or 10 litres or less, or 8 litres or less, or even 6 litres or less of water. Typically from 0.01 kg to 2 kg of fabric per litre of wash liquor is dosed into said wash liquor. Typically the wash liquor comprising the detergent of the invention has a pH of from 3 to 11.5, typically from 7 to 10.

The laundering step may be followed by one or more optional rinsing steps. In the post-wash-treatment step (iii), the fabric is treated with the fabric softener composition. Preferably this is by contact with an aqueous rinse liquor comprising and fabric softener component. This can be achieved by adding the softener composition described herein into the rinse water, either in a hand washing processing or in a laundry washing machine rinse step. This step is preferably the final rinse step, immediately before drying the fabric. If desired a rinse step may take place between the rinse-treatment step and drying the fabric.

Drying of the fabric may be by any conventional means either in domestic or industrial settings: machine drying or open-air drying. The fabric may comprise any fabric capable of being laundered in normal consumer or institutional use conditions, and the invention is suitable for synthetic textiles such as polyester and nylon and natural fabrics comprising cellulosic fabrics and mixed fabrics comprising synthetic and natural fibres, such as polycotton. The water temperature in the rinse step is typically in the range from about 5° C. to about 90° C., though lower water temperatures up to 60 or 40 or 30° C. are useful. The water to fabric ratio is typically from about 1:1 to about 30:1.

The detergent composition will comprise a surfactant system and optional additional adjuncts.

### Surfactant System

The surfactant system comprises an anionic surfactant and/or a nonionic surfactant wherein the weight ratio of anionic to non-ionic surfactant is from 1.5:1 to 1:10, preferably from 1.2:1 to 1:5, more preferably from 1:1 to 1:4.

The total surfactant level in the cleaning composition is preferably from 5 to 80% by weight, or from 10 to 50% by weight, more preferably from 15 to 45% by weight.

### Anionic Surfactant

The anionic surfactant may comprise one surfactant or typically mixtures of more than one surfactant. Preferred anionic detersive surfactants are alkyl benzene sulfonates, alkoxylated anionic surfactant, or a combination thereof. Suitable anionic detersive surfactants include sulphate and sulphonate detersive surfactants.

Particularly preferred alkyl benzene sulphonates are linear alkylbenzene sulphonates, particularly those having a carbon chain length of C8-15, or C10-13 alkyl benzene sulphonate. Suitable alkyl benzene sulphonate (LAS) is obtainable, or even obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. Another suitable anionic detersive surfactant is alkyl benzene sulphonate that is obtained by DETAL catalyzed process, preferably having 8 to 15 carbon atoms. Other synthesis routes, such as HF, may also be suitable.

Suitable sulphate detersive surfactants include alkyl sulphate, such as C8-18 alkyl sulphate, or predominantly C12 alkyl sulphate. The alkyl sulphate may be derived from natural sources, such as coco and/or tallow. Alternatively, the alkyl sulphate may be derived from synthetic sources such as C12-15 alkyl sulphate.

It may be preferred for the surfactant composition to comprise as additional anionic surfactant, in addition an alkyl alkoxylated sulphate, such as alkyl ethoxylated sulphate, or a C8-18 alkyl alkoxylated sulphate, or a C8-18 alkyl ethoxylated sulphate. Preferably the alkyl chain length may be from 12 to 16 carbon atoms. The alkyl alkoxylated sulphate may have an average degree of alkoxylation of from 0.5 to 20, or from 0.5 to 10, or from 0.5 to 7, or from 0.5 to 5 or from 0.5 to 3. Examples include predominantly C12 sodium lauryl ether sulphate ethoxylated with an average of 3 moles of ethylene oxide per mole.

The alkyl sulphate, alkyl alkoxylated sulphate and alkyl benzene sulphonates may be linear or branched, substituted or un-substituted.

The anionic detersive surfactant may be a mid-chain branched anionic detersive surfactant, such as a mid-chain branched alkyl sulphate and/or a mid-chain branched alkyl benzene sulphonate. The mid-chain branches are typically C1-4 alkyl groups, such as methyl and/or ethyl groups.

Another suitable anionic detersive surfactant is alkyl ethoxy carboxylate.

The anionic surfactants are typically present in their salt form, typically being complexed with a suitable cation. Suitable counter-ions include Na+ and K+, substituted ammonium such as C1-C6 alkanolammnonium such as mono-ethanolamine (MEA) tri-ethanolamine (TEA), di-ethanolamine (DEA), and any mixture thereof.

In the cleaning compositions, when alky (optionally ethoxylated) sulphates are present preferably the weight ratio of linear alkyl benzene sulphonate to alkyl sulphate and/or alkyl alkoxylated sulphate is from 20:1 to 1:2, more preferably from 5:1 to 1:1. Typically the anionic surfactant is present in the cleaning composition in an amount from 5 to 30 wt % anionic surfactant, or from at least 8 or at least 10% by weight anionic surfactant.

Herein, fatty acid is not considered as a surfactant.

### Nonionic Surfactant

Suitable non-ionic surfactants are selected from the group consisting of: C₈-C₁₈ alkyl ethoxylates, such as, NEODOL® non-ionic surfactants from Shell; C₆-C₁₂ alkyl phenol alkoxylates wherein the alkoxylate units may be ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, typically having an average degree of alkoxylation of from 1 to 30; alkylpolysaccharides, in one aspect, alkylpolyglycosides; polyhydroxy fatty acid amides; ether capped poly(oxyalkylated) alcohol surfactants; and mixtures thereof.

Suitable non-ionic detersive surfactants include alkyl polyglucoside and/or an alkyl alkoxylated alcohol.

When alkyl alkoxylated alcohols are present, preferably they are selected from C₈₋₁₈ alkyl alkoxylated alcohol, for example a C₈₋₁₈ alkyl ethoxylated alcohol. Preferably the alkyl alkoxylated alcohol has an average degree of alkoxylation of from 1 to 80, preferably from 1 to 50, most preferably from 1 to 30, from 1 to 20, or from 1 to 10. Preferred nonionic surfactants may be C₈₋₁₈ alkyl alkoxylated, preferably ethoxylated alcohols having an average degree of alkoxylation, preferably ethoxylation of from 1 to 10, from 1 to 7, more from 1 to 5 or from 3 to 7, or even below 3 or 2. The alkyl alkoxylated alcohol can be linear or branched, and substituted or un-substituted.

Suitable nonionic surfactants include those with the tradename Lutensol® (BASF).

Typically the nonionic surfactant is present in the cleaning composition in an amount from 4 to 40 wt % anionic surfactant, or from at least from 8 or at least from 10% by weight, or from 12 10% by weight nonionic surfactant.

Detergent compositions may be in any suitable form, for example, solid such as powder detergent or liquid or in unit dose form. It may be preferred for a liquids to be an externally structured aqueous isotropic liquid laundry detergent composition.

The wash liquor comprises from 0.1 g/l to 5 g/l of the surfactant system.

### Detergent Composition Adjunct Materials

Further suitable adjuncts may be, for example to assist or enhance cleaning performance, or to modify the aesthetics of the detergent composition as is the case with perfumes, colorants, non-fabric-shading dyes or the like. Suitable adjunct materials include, but are not limited to, surfactants, builders, chelating agents, dispersants, enzymes, and enzyme stabilizers, catalytic materials, bleach activators, hydrogen peroxide, sources of hydrogen peroxide, preformed peracids, polymeric dispersing agents, clay soil removal/anti-redeposition agents, cleaning polymers including soil release polymers and dye transfer inhibitors, additional brighteners, suds suppressors, dyes, hueing dyes, perfumes, perfume delivery systems, structure elasticizing agents, fabric softeners, carriers, hydrotropes, processing aids, solvents, additional dyes and/or pigments.

### Methods

For each method applied to a fabric softener composition, a visually homogeneous sample is used. In case the fabric softener composition is visually not homogeneous, the entire fabric softener composition is homogenized in a way to avoid air entrapment, prior to sampling to ensure representative sampling.

### Method for Determining Viscosity and Dynamic Yield Stress

Viscosity and dynamic yield stress are measured using a controlled stress rheometer (such as an HAAKE MARS from Thermo Scientific, or equivalent), using a 60 mm parallel plate and a gap size of 500 microns at 20° C. The viscosity and dynamic yield stress are obtained by measuring quasi steady state shear stress as a function of shear rate in the range starting from 10 s⁻¹ to 10⁻⁴ s⁻¹, taking 25 points logarithmically distributed over the shear rate range. Quasi-steady state is defined as the shear stress value once variation of shear stress over time is less than 3%, after at least 30 seconds and a maximum of 60 seconds at a given shear rate. Variation of shear stress over time is continuously evaluated by comparison of the average shear stress measured over periods of 3 seconds. If after 60 seconds measurement at a certain shear rate, the shear stress value varies more than 3%, the final shear stress measurement is defined as the quasi state value for calculation purposes. The viscosity of the fabric softener composition is defined as the measured shear stress divided by the applied shear rate of 10 s⁻¹.

Shear stress data is then fitted using least squares method in logarithmic space as a function of shear rate following a Herschel-Bulkley model:

τ=τ₀+k\dot{γ}ⁿ

wherein τ is the measured equilibrium quasi steady state shear stress at each applied shear rate \dot{γ}, τ₀ is the fitted dynamic yield stress. k and n are fitting parameters.

### Method of Determining pH of a Fabric Softener Composition

The pH is measured on the neat fabric softener composition, using a Sartorius PT-10P pH meter with gel-filled probe (such as the Toledo probe, part number 52 000 100), calibrated according to the instructions manual.

### Method for Determining Fabric Softener Active by CatSO3 Titration

The fabric softener activity is determined by cationic CatSO₃ titration as described in ISO2871.

Specifically, to a sample containing cationic fabric softener active, a mixed indicator composed of a cationic and an anionic dye is added under stirring in a water-chloroform system. The cationic fabric softener active-anionic dye complex is blue and chloroform soluble, whereas the red cationic dye remains dissolved in the aqueous phase. Upon titration with anionic surfactant (standardized sodium dodecyl sulfate, “NaLS”), the blue dye-surfactant complex in the chloroform breaks and a colorless cationic fabric softening active-anionic titrant complex is formed while the liberated blue dye migrates back into the aqueous phase. A color change from blue to grey in the chloroform layer indicates the endpoint. Excess anionic surfactant forms a complex with the red cationic dye, giving a pink to red color to the chloroform layer.

### Calculation:

% Cationic SO3 equivalent=[(V*N)]*0.080*100/W

### Where:

### V=mL NaLS Standard Solution

### N=Normality of NaLS Standard Solution

### 0.080=Milliequivalent Weight of SO3

W=Sample weight in g

### Method for Determining Dispenser Residue:

Following setup is used to simulate the final rinse cycle in the dispenser of the washing machine.

The dispenser drawer PP-T40 corresponding to a Miele Novotronic W986 washing machine is fixed in horizontal position. Then, 25 grams of the fabric softener composition is added into the fabric softener composition compartment of the dispenser drawer.

A total flow of 3.47 kg of water of 2.5 mmol/L hardness is flushed through the dispenser in 80 seconds at 20° C. by using a “cylindrical nozzle” located horizontally 2.5 cm above and parallel to the dispenser compartment. Such cylindrical nozzle having a diameter of 4 cm and a length of 12.8 cm with 3 orifices of 0.5 cm diameter located corresponding to the orifices of the fabric care composition compartment of the dispenser drawer.

Rinse water containing the fabric care composition is collected in a bucket containing 5 kg of 2.5 mmol/L hardness water and homogenized with an IKA EURO-ST P VC with an R 2302 4-bladed Propeller stirrer at 450 rpm for 1 minute after water flow has finished. The total rinse water mass obtained at the end of the dispenser residue test is 8.47 kg.

The fabric softener activity, measured using CatSO3 titration, is measured of the fabric softener composition added into the dispenser and of the rinse water.

Dispensing residue expressed in % is calculated as:

$$\frac{0.025 CatSO {3}_{( fabric softener composition )} - 8.47 \cdot CatSO {3}_{( rinse water )}}{0.025 \cdot CatSO {3}_{( fabric softener composition )}}$$

wherein
CatSO3_{(fabric softener composition)} is the % Cationic SO3 Equivalent determined by CatSO3 titration of the fabric softener composition;
CatSO3_{(rinse water)} is the % Cationic SO3 Equivalent determined by CatSO3 titration of the rinse water collected at the end of the dispenser residue test.

### Examples

The following are exemplary fabric softener compositions of the present invention

TABLE 1
Liquid fabric softener compositions examples 1 through 8.

| | Weight % | | | |
|---|---|---|---|---|
| | Ex. 1 | Ex. 2 | Ex. 3 | Ex. 4 |
| NaHEDP | 0.007 | 0.007 | 0.007 | 0.007 |
| Formic acid | 0.044 | 0.044 | 0.044 | — |
| HCl | — | 0.009 | 0.009 | 0.009 |
| Preservative^{a} | 0.022 | 0.01 | 0.01 | 0.01 |
| FSA^{b} | 7.6 | 7.6 | 7.6 | 7.6 |
| Antifoam^{c} | 0.1 | 0.1 | 0.1 | 0.1 |
| coconut oil | 0.3 | 0.3 | 0.3 | 0.3 |
| isopropanol | 0.78 | 0.78 | 0.77 | 0.77 |
| Encapsulated perfume^{d} | 0.15 | 0.15 | 0.15 | 0.15 |
| dye | 0.015 | 0.015 | 0.015 | 0.015 |
| Cationic polymeric thickener^{e} | 0.15 | 0.20 | 0.28 | 0.35 |
| Water soluble dialkyl quat^{f} | — | 0.2 | — | — |
| 50:50 Blend of alkyl dimethyl benzyl | — | — | 0.4 | — |
| ammonium chloride and alkyl dimethyl | | | | |
| ethylbenzyl ammonium chloride^{g} | | | | |
| C8-10 dimethyl amide^{h} | 3 | — | — | 6 |
| C10 dimethyl amideⁱ | — | 6 | — | — |
| C12 dimethyl amide^{j} | — | — | 5 | — |
| Hydrogen Peroxide | — | — | — | 4.5 |
| Silver citrate | 0.3 | — | — | — |
| Succinic acid | — | — | — | 5 |
| Perfume | 1.0 | 1.0 | 1.0 | 1.0 |
| deionized water | Bal- | Bal- | Bal- | Bal- |
| | ance | ance | ance | ance |
| | Weight % | | | |
| | Ex. 5 | Ex. 6 | Ex. 7 | Ex. 8 |
| NaHEDP | 0.007 | 0.007 | 0.007 | 0.007 |
| Formic acid | — | 0.043 | — | 0.043 |
| HCl | 0.009 | 0.009 | 0.009 | 0.009 |
| Preservative^{a} | 0.021 | 0.01 | 0.021 | 0.021 |
| FSA^{b} | 7.4 | 7.4 | 7.3 | 7.3 |
| Antifoam^{c} | 0.1 | 0.1 | 0.1 | 0.1 |
| coconut oil | 0.3 | 0.3 | 0.3 | 0.2 |
| isopropanol | 0.76 | 0.76 | 0.75 | 0.75 |
| Encapsulated perfume^{d} | 0.15 | 0.15 | 0.15 | 0.15 |
| dye | 0.015 | 0.015 | 0.015 | 0.015 |
| Cationic polymeric thickener^{e} | 0.22 | — | — | — |
| Water soluble dialkyl quat^{f} | — | 0.3 | — | 0.25 |
| 50:50 Blend of alkyl dimethyl benzyl | 0.1 | — | — | — |
| ammonium chloride and alkyl dimethyl | | | | |
| ethylbenzyl ammonium chloride^{g} | | | | |
| C8-10 N-N dimethyl amide^{h} | 6 | — | — | — |
| C10 dimethyl amideⁱ | — | — | 5 | — |
| Unsat. C10 dimethyl amide^{k} | — | 4 | — | 5.5 |
| Lactic acid | — | — | 2.5 | 0.1 |
| Succinic acid | 4 | — | — | 0.1 |
| Perfume | 1.0 | 1.0 | 1.0 | 1.0 |
| deionized water | Bal- | Bal- | Bal- | Bal- |
| | ance | ance | ance | ance |

^{a}Proxel GXL, 20% aqueous dipropylene glycol solution of 1,2-benzisothiazolin-3-one, supplied by Lonza.
^{b}N,N-bis(hydroxyethyl)-N,N-dimethyl ammonium chloride fatty acid ester. The iodine value of the parent fatty acid of this material is between 18 and 22. The material as obtained from Evonik contains impurities in the form of free fatty acid, the monoester form of N,N-bis(hydroxyethyl)-N,N-dimethyl ammonium chloride fatty acid ester, and fatty acid esters of N,N-bis(hydroxyethyl)-N-methylamine.
^{c}MP10 ®, supplied by Dow Corning, 8% activity
^{d}as described in U.S. Pat. No. 8,765,659, expressed as 100% encapsulated perfume oil
^{e}Rheovis ® CDE, cationic polymeric thickener supplied by BASF
^{f}Bardac ™2250 supplied by Lonza
^{g}Barquat ™ 4280Z, supplied by Lonza
^{h}N,N-dimethyl octanamide and N,N-dimethyl decanamide in about a 55:45 weight ratio, tradename Steposol ® M-8-10 from the Stepan Company
ⁱN,N-dimethyl decanamide tradename Steposol ® M-10 from the Stepan Company
^{j}N,N-dimethyl dodecanamide (lauric acid, N-N-dimethyl amide) from Santa Cruz Biotechnology
^{k}N,N-dimethyl-9-decenamide (monounsaturated amide), tradename Steposol ® MET-10U form the Stepan company

TABLE 2
Liquid fabric softener compositions examples 9 through 20

| | Weight % | | | | | |
|---|---|---|---|---|---|---|
| | Ex. 9 | Ex. 10 | Ex. 11 | Ex. 12 | Ex. 13 | Ex. 14 |
| FSA^{a} | 9.2 | 7 | — | — | — | — |
| FSA^{b} | — | — | — | 9.3 | 12.5 | — |
| FSA^{c} | — | — | 5 | — | — | 8.5 |
| Coco oil | 0.735 | 0.1 | 0.51 | 0.3 | 0.6 | 0.8 |
| Low MW Alcohol^{d} | 0.58 | 0.11 | 0.58 | 0.95 | 0.95 | 0.95 |
| Perfume | 1.65 | 3.5 | 1.65 | 1.00 | 1.60 | 1.00 |
| Perfume encapsulate^{e} | 0.26 | 1.33 | 0.26 | 0.25 | 0.25 | 0.25 |
| Calcium Chloride | 0.12 | 0.05 | — | 0.12 | 0.16 | 0.07 |
| Chelant^{f} | 0.01 | 0.01 | 0.01 | 0.01 | 0.01 | 0.01 |
| Preservative^{g} | 0.001 | — | 0.001 | — | — | — |
| Acidulent (Formic Acid) | — | 0.06 | — | 0.06 | — | 0.06 |
| Antifoam^{h} | — | 0.02 | — | — | — | — |
| Dispersant^{j} | — | — | 0.15 | — | — | 0.10 |
| Stabilizing Surfactant^{k} | — | — | 0.45 | 0.50 | 0.1 | 0.10 |
| Stabilizing Surfactant^{l} | — | — | 0.10 | — | 0.25 | — |
| Floc preventing agent^{m} | 0.40 | — | — | — | — | 0.12 |
| PDMS emulsionⁿ | 1.12 | — | 0.85 | — | — | — |
| Dye | 0.03 | 0.03 | — | 0.03 | 0.03 | 0.03 |
| Hydrochloric Acid | 0.03 | 0.03 | 0.03 | 0.03 | 0.03 | 0.03 |
| Water soluble dialkyl quat^{o} | 0.1 | 0.05 | — | — | 0.01 | 0.15 |
| 50:50 Blend of alkyl | — | — | 0.05 | 0.2 | — | — |
| dimethyl benzyl ammonium | | | | | | |
| chloride and alkyl dimethyl | | | | | | |
| ethylbenzyl ammonium | | | | | | |
| chloride^{p} | | | | | | |
| C8-10 N-N dimethyl amide^{q} | 4 | — | — | — | — | — |
| C10 dimethyl amide^{r} | — | 6 | 5 | — | — | — |
| C12 dimethyl amide^{s} | — | — | — | — | 6 | — |
| Unsat. C10 dimethyl amide^{t} | — | — | — | 4.5 | — | 5 |
| Lactic acid | — | — | 1 | — | 2.5 | — |
| Succinic acid | 3 | — | — | — | — | — |
| Deionized Water | Balance | Balance | Balance | Balance | Balance | Balance |
| | Weight % | | | | | |
| | Ex. 15 | Ex. 16 | Ex. 17 | Ex. 18 | Ex. 19 | Ex. 20 |
| FSA^{u} | 4.3 | 7 | 9 | 11 | 14.7 | 18 |
| Coco oil | — | 0.5 | — | — | — | — |
| Low MW Alcohol^{d} | — | — | — | — | — | 0.5 |
| Perfume | 0.7 | 2.2 | 2.2 | 3.3 | 1.60 | 1.2 |
| Perfume encapsulate^{e} | — | 1.33 | 0.26 | 0.25 | 0.25 | 0.25 |
| Calcium Chloride | — | 0.03 | 0.045 | 0.12 | 0.15 | 0.2 |
| Chelant^{f} | 0.01 | 0.01 | 0.01 | 0.01 | 0.01 | 0.01 |
| Preservative^{g} | 0.001 | — | 0.001 | — | — | — |
| Acidulent (Formic Acid) | — | 0.06 | — | 0.06 | 0.06 | — |
| Antifoam^{h} | — | 0.02 | — | — | — | — |
| Dispersant^{j} | — | — | 0.15 | — | — | 0.10 |
| Stabilizing Surfactant^{k} | — | — | 0.1 | 0.156 | — | — |
| Stabilizing Surfactant^{l} | — | — | 0.10 | — | — | — |
| Floc preventing agent^{m} | 0.40 | 0.4 | 0.4 | — | — | — |
| Amino-functional | — | 3.1 | 0.95 | — | — | — |
| Organosiloxane Polymer | | | | | | |
| Dye | 0.03 | 0.03 | — | 0.03 | 0.03 | 0.03 |
| Hydrochloric Acid | 0.02 | 0.03 | 0.03 | 0.03 | 0.035 | 0.035 |
| Water soluble dialkyl quat^{o} | 0.2 | — | 0.1 | — | — | 0.03 |
| 50:50 Blend of alkyl dimethyl | — | 0.3 | — | — | 0.04 | — |
| benzyl ammonium chloride | | | | | | |
| and alkyl dimethyl | | | | | | |
| ethylbenzyl ammonium | | | | | | |
| chloride^{p} | | | | | | |
| C8-10 N-N dimethyl amide^{q} | 4 | — | — | — | — | — |
| C10 dimethyl amide^{r} | — | 3 | — | 6 | 6 | — |
| C12 dimethyl amide^{s} | — | — | 6 | — | — | — |
| Unsat. C10 dimethyl amide^{t} | — | — | — | — | — | 5 |
| Silver Citrate | — | — | — | 0.1 | — | — |
| Lactic acid | — | — | — | 1 | — | 2 |
| Succinic acid | 1 | — | — | — | — | — |
| Deionized Water | Balance | Balance | Balance | Balance | Balance | Balance |

^{a}reaction product of Methyl-diethanolamine with fatty acids, in molar ratio ranging from 1:1.5 to 1:2, fully or partially quaternized with methylchloride. The fatty acid has a chain length distribution comprising about 35-55% saturated C18 chains, 10-25% mono-unsaturated C18 chains, and has an iodine value of about 20. Material available from Evonik.
^{b}reaction product of Tri-ethanolamine with fatty acids in molar ratio ranging from 1:1.5 to 1:2, fully or partially quaternized with dimethylsulphate. The fatty acid has a chain length distribution of about 35-55% saturated C18 chains, 15-25% mono-unsaturated C18 chains, and an iodine value of about 40. Material available from Stepan.
^{c}reaction product of Methyl-diisopropanolamine with fatty acids, mixed in a molar ratio ranging from 1:1.5 to 1:2, fully or partially quaternized with dimethylsulphate. The fatty acid has a chain length distribution comprising less than 10% saturated C18 chains, about 20-30% mono-unsaturated C18 chains, about 50-70% C16 chains, and an iodine of about 35. Material available from Evonik
^{d}Low molecular weight alcohol such as ethanol or isopropanol.
^{e}Perfume microcapsules available ex Appleton Papers, Inc.
^{f}Diethylenetriaminepentaacetic acid or hydroxyl ethylidene-1,1-diphosphonic acid.
^{g}1,2-Benzisothiazolin-3-ONE (BIT) under the trade name Proxel available from Lonza.
^{h}Silicone antifoam agent available from Dow Corning ® under the trade name DC2310.
^{j}Non-ionic surfactant from BASF under the trade name Lutensol ® XL-70.
^{k}Non-ionic surfactant, such as TWEEN 20 ™, Lutensol AT25 (ethoxylated alcohol with an average degree of ethoxylation of 25 from BASF).
^{l}Ethoxylated cationic surfactant such as Berol R648 (average degree of ethoxylation of 15 from Akzo Nobel) or Variquat K1215 (average degree of ethoxylation of 15 from Evonik).
^{m}Nonionic surfactant such as Lutensol AT80 (ethoxylated alcohol with an average degree of ethoxylation of 80 from BASF) or Genapol T680 (ethoxylated alcohol with an average degree of ethoxylation of 68 from Clariant).
ⁿPolydimethylsiloxane emulsion from Dow Corning under the trade name DC346 ®
^{o}Bardac ™ 2250 supplied by Lonza
^{p}Barquat ™ 4280Z, supplied by Lonza
^{q}N,N-dimethyl octanamide and N,N-dimethyl decanamide in about a 55:45 weight ratio, tradename Steposol ® M-8-10 from Stepan Company
^{r}N,N-dimethyl decanamide tradename Steposol ® M-10 from the Stepan Company
^{s}N,N-dimethyl dodecanamide (lauric acid, N-N-dimethyl amide) from Santa Cruz Biotechnology
^{t}N,N-dimethyl-9-decenamide (monounsaturated amide), tradename Steposol ® MET-10U form the Stepan company
^{u}Reaction product of Methyl-diisopropanolamine with fatty acids, mixed in a molar ratio ranging from 1:1.5 to 1:2, fully or partially quaternized with dimethylsulphate. The fatty acid has a chain length distribution comprising about 35-55% saturated C18 chains, 10-25% mono-unsaturated C18 chains, and has an iodine value of about 20. Material available from Evonik.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric softener composition comprising (i) 2 to 50 wt % quaternary ammonium ester fabric softener compound; and (ii) an amide of formula I:
R1-CO—NR2R3 (I)
wherein R1 is selected from the group consisting of linear or branched, substituted or unsubstituted C6-C12, each of R2 and R3 is independently selected from H, OH, a halogen, or C1-C6 linear or branched, substituted or unsubstituted hydrocarbyl groups; and optionally an antimicrobial active.

2. A fabric softener composition according to claim 1 wherein in said amide of formula I, R¹ is selected from the group consisting of linear or branched, substituted or unsubstituted C₆-C₁₀ hydrocarbyl groups.

3. A fabric softener composition according to claim 1 wherein the amide is selected from the group consisting of N,N-dimethyl octanamide, N,N-dimethyl decanamide, N,N-dimethyl 9-decenamide, N,N-dimethyl 7-octenamide, octanohydroxamic acid, and mixtures thereof.

4. A fabric softener composition according to claim 1 wherein the amide is present in an amount from 0.03 wt % to 25 wt % of the composition.

5. A fabric softener composition according to claim 1 wherein the quaternary ammonium ester compound has the following formula:
{R²₍₄₋ₘ₎—N⁺—[X—Y—R¹]ₘ}A⁻
wherein:
m is 1, 2 or 3 with proviso that the value of each m is identical;
each R¹ is independently hydrocarbyl, or branched hydrocarbyl group;
each R² is independently a C₁-C₃ alkyl or hydroxyalkyl group;
each X is independently (CH₂)ₙ, CH₂—CH(CH₃)— or CH—(CH₃)—CH₂— and
each n is independently 1, 2, 3 or 4;
each Y is independently —O—(O)C— or —C(O)—O—;
A− is independently selected from the group consisting of chloride, methyl sulfate, and ethyl sulfate;
with the proviso that when Y is —O—(O)C—, the sum of carbons in each R¹ is from 13 to 21, or mixtures thereof.

6. A fabric softener composition according to claim 1 wherein the quaternary ammonium ester compound has the following formula:
{R²₍₄₋ₘ₎—N⁺—[X—Y—R¹]ₘ}A⁻
wherein:
m is 1, 2 or 3 with proviso that the value of each m is identical;
each R¹ is unsaturated linear alkyl chain;
each R² is selected from methyl, ethyl, propyl, hydroxyethyl, 2-hydroxypropyl, 1-methyl-2-hydroxyethyl, poly(C₂₋₃ alkoxy), polyethoxy, benzyl;
each X is independently (CH₂)ₙ, CH₂—CH(CH₃)— or CH—(CH₃)—CH₂— and each n is 2;
each Y is independently —O—(O)C— or —C(O)—O—;
A− is selected from the group consisting of chloride and methyl sulfate;
with the proviso that when Y is —O—(O)C—, the sum of carbons in each R¹ is from 13 to 21, or mixtures thereof.

7. A fabric softener composition according to claim 1 having a pH from 1 to 8.

8. A fabric softener composition according to claim 1 having a pH from about 2.5 to about 5.0.

9. A fabric softener composition according to claim 1 additionally comprising an acidifying agent.

10. A fabric softener composition according to claim 1 additionally comprising an acidifying agent in an amount from about 0.03 wt % to about 25 wt % of the composition.

11. A fabric softener composition according to claim 1 additionally comprising an acidifying agent wherein said acidifying agent is selected from the group consisting of formic acid, acetic acid, benzoic acid, malonic acid, citric acid, maleic acid, fumaric acid, succinic acid, gluconic acid, glutaric acid, lactic acid, 2-ethyl-1-hexanoic acid, cinnamic acid, salicylic acid, heptanoic acid, octanoic acid, nonanoic acid, undecylenic acid, and mixtures thereof.

12. A fabric softener composition according to claim 1 additionally comprising an acidifying agent wherein said acidifying agent is selected from the group consisting of formic acid, citric acid, lactic acid, succinic acid, and salicylic acid.

13. A fabric softener composition according to claim 1 comprising from about 0.01 to about 30 wt % antimicrobial active.

14. A fabric softener composition according to claim 1 wherein the antimicrobial active is selected from ionic silver, an active oxygen source, an antimicrobial quaternary ammonium compound, or mixtures thereof.

15. A fabric softener composition according to claim 1 wherein the antimicrobial active comprises an active oxygen source or mixtures thereof, comprising hydrogen peroxide.

16. A fabric softener composition according to claim 1 wherein the antimicrobial active comprises an antimicrobial quaternary ammonium compound, or mixtures thereof.

17. A method of treating a fabric, the method comprising contacting the fabric with a composition according to claim 1.

18. A method of treating a fabric wherein the method comprises (i) in a laundering/wash step, treating a fabric with an aqueous wash liquor comprising from about 0.1 g/l to about 5 g/l of a surfactant system, comprising anionic and/or nonionic surfactant; (ii) optionally rinsing the textile one or two or more times with water; and (iii) in a post-wash-treatment step, contacting the fabric with a composition according to claim 1.

19. A method of treating a fabric wherein the method comprises (i) in a laundering/wash step, treating a fabric with an aqueous wash liquor comprising from about 0.1 g/l to about 5 g/l of a surfactant system, comprising anionic and/or nonionic surfactant; (ii) optionally rinsing the textile one or two or more times with water; and (iii) a post-wash-treatment step comprising a rinse step, the rinse liquor comprising water and fabric softener composition according to claim 1 and the fabric is dried in step a drying step (iv).
